(19) United States
(12) Patent Application Publication
(10) Pub. No.: US 2008/0316185 A1
(43) Pub. Date: Dec. 25, 2008

(54) Wireless multiuser meeting/interactive class device with memory card connectors

(76) Inventor: Hsien-Chung Chou, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,396

(22) Filed: Jan. 10, 2008

Related U.S. Application Data
(63) Continuation-in-part of application No. 11/819,006, filed on Jun. 25, 2007.

(30) Foreign Application Priority Data
Nov. 30, 2007 (TW) 096220291

(51) Int. Cl. G06F 3/041

(52) U.S. Cl. 345/173

(57) ABSTRACT

A wireless multiuser meeting/interactive class device with memory card connectors. The device includes a host control end unit having a memory card connector wherein a memory card can be inserted. The host control end unit can pick up the data of the memory card to show the data on a display connected with the computer. The device further includes several sub-control end units each including a touch control handwriting pad section, a wireless transceiver unit and a memory card connector. The signals generated by the touch control handwriting pad section or the data picked up from the memory card inserted in the memory card connector are transmitted by the wireless transceiver unit. The wireless transceiver unit of the host control end unit serves to receive the signals or data to show the signals or data on the display connected with the computer.

### CROSS-REFERENCE TO RELATED APPLICATION

This application is a Continuation-in-Part application of U.S. patent application Ser. No. 11/819,006, entitled “Wireless Multi-User Touch Control Device”, filed on 20 Jun. 2007, now pending.

### BACKGROUND OF THE INVENTION

1. Field of the Invention

The present invention is related to a wireless multiuser meeting/interactive class device with memory card connectors, and more particularly to a wireless multiuser meeting/interactive class device including a host control end unit and multiple sub-control end units each of which is equipped with a memory card connector in which a memory card can be inserted. The data of the memory cards can be picked up and shown on a display.

2. Description of the Prior Art

FIG. 1 shows a current wired single handwriting input board 51. The handwriting input board 51 is connected to a computer mainframe 53 via a connecting wire 52. A user can touch the handwriting input board 51 to write characters or draft drawings on the handwriting input board 51. Through the processing of the computer mainframe 53, the signals are transmitted to a display 54 for showing the characters or drawings. Such handwriting input board 51 can be used in various fields such as personal demonstration.

The handwriting input board 51 is connected to the computer mainframe 53 via the connecting wire 52. Therefore, when used, it is necessary to lay out the wire. Such procedure is quite troublesome. Moreover, due to the limitation of the layout of the connecting wire 52, it is impossible to freely change the location of the handwriting input board 51. Besides, in general, only one single handwriting input board 51 can be connected to one computer mainframe 53 for one user to use. Therefore, it is impossible to use such single handwriting input board 51 in a multiuser meeting such as a multiuser interactive class of a teacher and many students.

FIG. 2 shows a wireless multi-user touch control device previously disclosed by this applicant. The wireless multiuser touch control device includes at least one input unit 61 having a touch control input pad 611 and a radio transmission element 612. A user can touch the touch control input pad 611 to write characters or draft drawings thereon. The input unit serves to convert the characters and drawings into digital signals which are transmitted by the radio transmission element 612 by way of radio frequency. The wireless multi-user touch control device further includes a receiving unit 62 having a receiver 621, a mainframe 622 and a display 623. The receiver 621 responsively receives the radio signals transmitted from the input unit 61 and inputting the radio signals to a processing unit of the mainframe 622 for processing the signals. Then the display 623 shows the characters or drawings identical to those written on the touch control input pad 611 of the input unit 61. According to the above arrangement, the input data are all the characters or drawings written on the touch control input pad 611. It is impossible for the user to show those files and data stored in a portable memory card.

### SUMMARY OF THE INVENTION

It is therefore a primary object of the present invention to provide a wireless multiuser meeting/interactive class device with memory card connectors. The device includes a host control end unit including a connector for connecting with an external unit, a processing unit, a wireless transceiver unit and a memory card connector. Via the connector for connecting with an external unit, the host control end unit is connectable to a computer. A memory card can be inserted in the memory card connector and the host control end unit can pick up the data of the memory card to be processed by the processing unit. Thereafter, the data are shown on a display connected with the computer. The signals generated by the display connected with the computer can be stored in the memory card inserted in the memory card connector of the host control end unit. The device further includes several sub-control end units each including a touch control handwriting pad section, a wireless transceiver unit and a memory card connector. The signals generated by the touch control handwriting pad section or the data picked up from the memory card inserted in the memory card connector are transmitted by the wireless transceiver unit. The wireless transceiver unit of the host control end unit serves to receive the signals or data which are then processed by the processing unit. Thereafter, the signals or data are shown on the display connected with the computer.

It is a further object of the present invention to provide the above wireless multiuser meeting/interactive class device which includes multiple sub-control end units. The signals generated by the sub-control units are receivable by the wireless transceiver unit of the host control end unit and shown on the display connected with the computer. Accordingly, the wireless multiuser meeting/interactive class device of the present invention is applicable to interactive class and multiuser meeting for real-time discussion.

The present invention can be best understood through the following description and accompanying drawings wherein:

### BRIEF DESCRIPTION OF THE DRAWINGS

FIG. 1 is a schematic diagram showing the application of a conventional single handwriting input board;

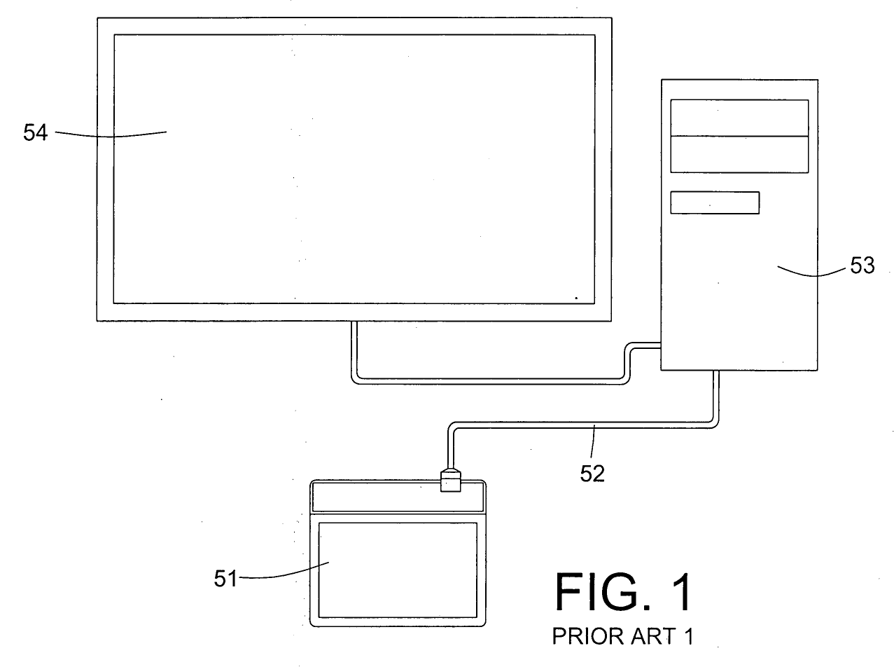

FIG. 2 is a schematic diagram of a wireless multiuser touch control device previously disclosed by this applicant; and

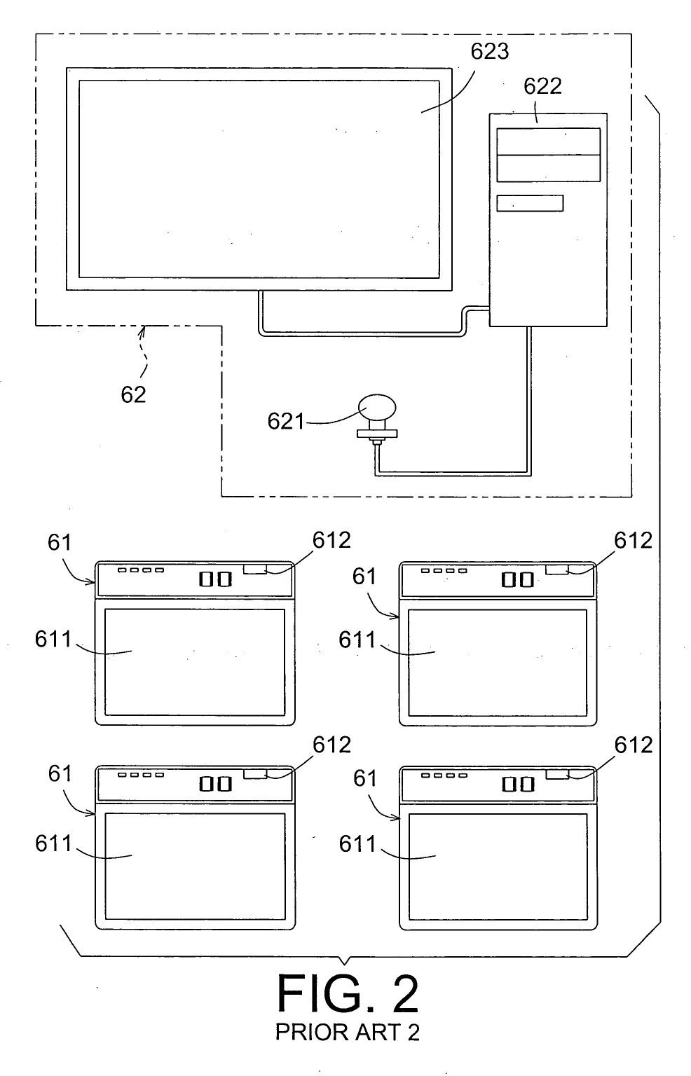

FIG. 3 is a schematic diagram of the present invention.

### DETAILED DESCRIPTION OF THE PREFERRED EMBODIMENTS

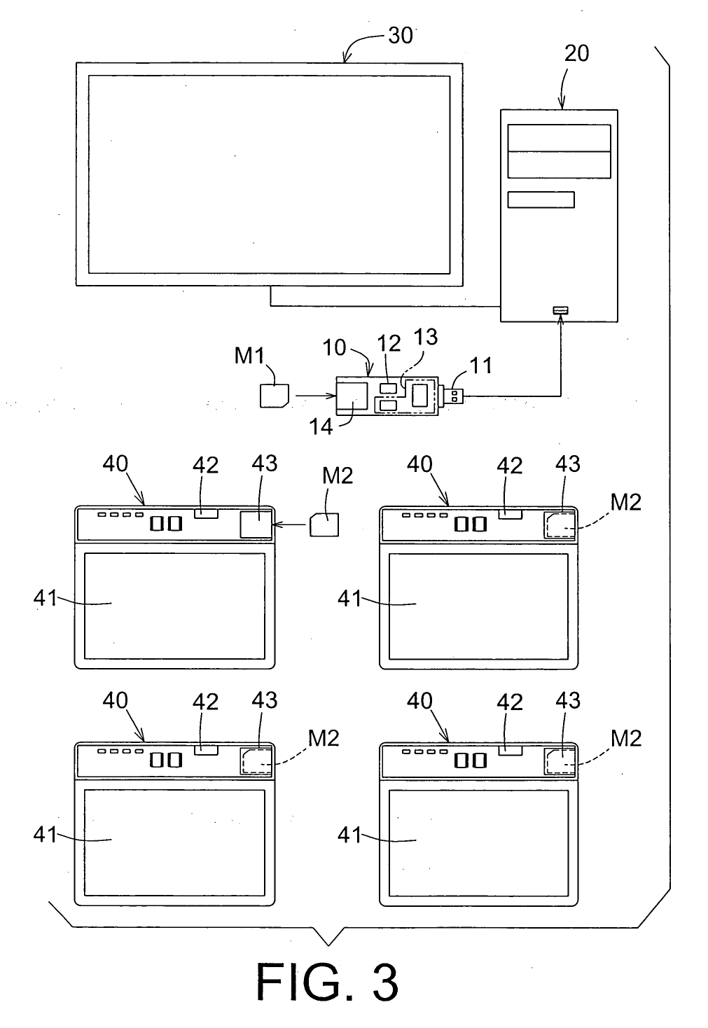

Please refer to FIG. 3. The wireless multiuser meeting/interactive class device with memory card connectors of the present invention includes a host control end unit 10 including a connector 11 for connecting with an external unit, a processing unit 12, a wireless transceiver unit 13 and a memory card connector 14. Via the connector 11, the host control end unit 10 can be connected to a computer 20. A memory card M1 can be inserted in the memory card connector 14. The host control end unit 10 can pick up the data of the memory card M1, which data are processed by the processing unit 12. Thereafter, the data are shown on a display 30 connected with the computer 20. Also, the signals generated by the display 30 can be stored in the memory card M1. The wireless multipartite meeting/interactive class device of the present invention further includes several sub-control end units 40 each including a touch control handwriting pad section 41, a wireless transceiver unit 42 and a memory card connector 43. The signals generated by the touch control handwriting pad section 41 or the data picked up from the memory card M2 inserted in the memory card connector 43 are transmitted by the wireless transceiver unit 42. The wireless transceiver unit 13 of the host control end unit 10 serves to receive the signals or data which are then processed by the processing unit 12. Then the signals or data are shown on the display 30 connected with the computer 20.

In the wireless multiuser meeting/interactive class device of the present invention, the display 30 connected with the computer 20 can be a light-emitting diode display or any other conventional display.

In the wireless multiuser meeting/interactive class device of the present invention, the signals shown on the display 30 connected with the computer 20 can be processed by the processing unit 12 of the host control end unit 10 and transmitted by the wireless transceiver unit 13. The signals are received by the wireless transceiver unit 42 of the sub-control end unit 40 and stored in the memory card M2 inserted therein.

The wireless multiuser meeting/interactive class device of the present invention includes multiple sub-control end units 40. The signals generated by the sub-control units 40 are received by the wireless transceiver unit 13 of the host control end unit 10 and shown on the display 30 connected with the computer 20. Accordingly, the present invention is applicable to interactive class and multiuser meeting for real-time discussion.

In the wireless multiuser meeting/interactive class device of the present invention, the display 30 connected with the computer 20 is one with touch control function, for example, an electronic whiteboard, a projector, a liquid crystal display or the like. This is not limited.

The wireless multiuser meeting/interactive class device of the present invention is characterized in that the host control end unit 10 and the sub-control end units 40 respectively have memory card connectors 14, 43 in which memory cards M1, M2 can be inserted. Therefore, a meeting chairman or a teacher controlling the host control end unit 10 can directly via the memory card connector 14 pick up the data stored in the memory card M1 and show the data on the display 30 for a briefing or a lesson. On the other hand, the members of the meeting or the students of the class at the sub-control end units 40 can via the touch control handwriting pad sections 41 to create corresponding characters or drawings on the display 30. In addition, the personal memory cards M2 can be inserted in the memory card connectors 43 to wirelessly transmit the data of the memory cards M2 to the host control end unit 10 and show the data on the display 30. Accordingly, the wireless multiuser meeting/interactive class device of the present invention is more widely applicable to various fields.

The above embodiments are only used to illustrate the present invention, not intended to limit the scope thereof. Many modifications of the above embodiments can be made without departing from the spirit of the present invention.

What is claimed is:

1. A wireless multiuser meeting/interactive class device with memory card connectors, comprising:
(a) a host control end unit including a connector for connecting with an external unit, a processing unit, a wireless transceiver unit and a memory card connector, via the connector for connecting with an external unit, the host control end unit being connectable to a computer, whereby a memory card can be inserted in the memory card connector and the host control end unit can pick up the data of the memory card to be processed by the processing unit, thereafter, the data being shown on a display connected with the computer; and
(b) several sub-control end units each including a touch control handwriting pad section, a wireless transceiver unit and a memory card connector, the signals generated by the touch control handwriting pad section or the data picked up from the memory card inserted in the memory card connector being transmitted by the wireless transceiver unit, the wireless transceiver unit of the host control end unit serving to receive the signals or data which are then processed by the processing unit, thereafter, the signals or data being shown on the display connected with the computer.

2. The wireless multiuser meeting/interactive class device with memory card connectors as claimed in claim 1, wherein the signals generated by the display connected with the computer can be stored in the memory card inserted in the memory card connector of the host control end unit.

3. The wireless multiuser meeting/interactive class device with memory card connectors as claimed in claim 1, wherein the signals shown on the display connected with the computer can be processed by the processing unit of the host control end unit and transmitted by the wireless transceiver unit thereof, the signals being received by the wireless transceiver unit of the sub-control end unit and stored in the memory card inserted therein.

4. The wireless multiuser meeting/interactive class device with memory card connectors as claimed in claim 1, wherein the device comprises multiple sub-control end units, the signals generated by the sub-control units being receivable by the wireless transceiver unit of the host control end unit and shown on the display connected with the computer.
